(19) United States
(12) Patent Application Publication
(10) Pub. No.: US 2013/0004714 A1
(43) Pub. Date: Jan. 3, 2013

(54) FILM COMPOSITE, USE OF THE FILM COMPOSITE, AND CREPE FILM COMPRISING THE FILM COMPOSITE

(75) Inventors: Matthias Mauser, Hausen (DE); Paul McKenna, Portland, OR (US)

(73) Assignee: Huhtamaki Forchheim Zweigniederlassung der Huhtamaki Deutschland GmbH & Co. KG, Forchheim (DE)

(21) Appl. No.: 13/529,009

(22) Filed: Jun. 21, 2012

Related U.S. Application Data
(60) Provisional application No. 61/500,755, filed on Jun. 24, 2011.

(30) Foreign Application Priority Data
Jun. 24, 2011 (DE) 10 2011 105 558.8

(51) Int. Cl. B32B 27/32; B32B 3/30; B32B 3/28; B32B 27/08

(52) U.S. Cl. 428/152; 428/523; 428/323; 428/476.9; 428/518; 428/172

(57) ABSTRACT

A film composite including a first external layer and a second external layer, a first middle layer between the first and the second external layer, wherein the first and/or second external layer comprise components which comprise at least a polyolefin, a component selected from the group consisting of microbeads, polystyrene, and high-molecular-weight polyethylene, and a polymer having a melting point lower than that of other components of the first and/or second external layer.

### RELATED APPLICATIONS

This application claims priority to German Patent Application No. 10 2011 105 558.8 filed Jun. 24, 2011 and U.S. Provisional Patent Application No. 61/500,755 filed Jun. 24, 2011, the subject matter of which is incorporated herein by reference.

### TECHNICAL FIELD

This disclosure relates to a film composite as well as the use of the film composite for a dry creping process and a crepe film comprising the film composite.

### BACKGROUND

Film composites used, for example, in the construction industry are often processed to give crepe films in order to achieve increased flexibility in their use. To obtain useful crepe films, the film composites from which the crepe films are produced have to be capable of resisting certain influences.

It could therefore be helpful to provide film composites having improved properties. It could also be helpful to provide a crepe film which comprises the film composite.

### SUMMARY

We provide a film composite including a first external layer and a second external layer, a first middle layer between the first and the second external layer, wherein the first and/or second external layer comprise components which comprise at least a polyolefin, a component selected from the group consisting of microbeads, polystyrene, and high-molecular-weight polyethylene, and a polymer having a melting point lower than that of other components of the first and/or second external layer.

We also provide a crepe film including a film composite having parallel corrugations.

### BRIEF DESCRIPTION OF THE DRAWINGS

FIG. 1 shows a schematical side view of a film composite.

FIG. 2 shows a schematical side view of a crepe film.

FIGS. 3a and 3b show photographs of plan views of a crepe film.

FIGS. 4a to 4f show enlarged photographs of plan views of film composites.

### DETAILED DESCRIPTION

It will be appreciated that the following description is intended to refer to specific examples of structure selected for illustration in the drawings and is not intended to define or limit the disclosure, other than in the appended claims.

We provide a film composite which comprises a first external layer and a second external layer, and also a first middle layer between the first and the second external layer. The first and/or the second external layer has components which comprise at least one polyolefin, a component selected from a group consisting of microbeads, polystyrene, and high-molecular-weight polyethylene, and a polymer, which has a melting point lower than that of the other components of the first and/or second external layer.

Microbeads in this context are spherical hollow moldings of which the shell can comprise a material selected from acrylonitrile copolymers. The microbeads can comprise a charge of a filler which, for example, comprises hydrocarbons which during processing at high temperature change from the liquid state to the gaseous state and thus can expand the microbeads. By way of example, the diameter of a microbead prior to any temperature increase can be one selected from the range from 15 to 40 μm, and after a temperature increase can be about 150 μm.

High-molecular-weight polyethylene in this context is ultrahigh-molecular-weight polyethylene (UHMWPE), the molar mass of which has been selected from the range from 3000 to 7000 kg/mol, corresponding to from 100 000 to 250 000 monomer units per polymer chain.

The polymer of which the melting point is lower than that of the other components of the first and/or second external layer can moreover have a melting point lower than that of all of the components of the film composite.

This type of film composite can be processed by a dry creping process to give a crepe film, where compression rates that can be achieved for the crepe film are higher than in film composites known hitherto. The good processability of the film composite is a result of high mechanical strength, for example, high resistance to pressure and/or to heat, due to the constitution of the film composite and of the individual layers of the film composite. The film composite moreover achieves increased resistance to mechanical loads, for example, tensile stresses, after it has been compressed by a creping process.

By virtue of the constitution in particular of the first and/or second external layer of the film composite it is possible, for example, to achieve adequate adhesion of the film composite on surfaces of transport rolls, for example, tungsten carbide surfaces, used in dry creping processes. Reduced or even no abrasion of the film composite occurs here so that by virtue of the conditions prevailing during the process, no or only slight residues form on the transport roll and transport capability is therefore maintained.

The properties of the film composite are therefore also determined by the components of the first and/or second external layer selected from a group consisting of microbeads, polystyrene, and high-molecular-weight polyethylene. By way of example, the use of microbeads, high-molecular-weight polyethylene, or polystyrene in the first and/or second external layer can achieve good adhesion of the film composite to surfaces of processing equipment, for example, tungsten-carbide-coated surfaces of a transport roll.

If a creping process achieves structuring of the film composite, for example, corrugation, this must be resistant to mechanical loads, in particular to tensile loads in further processing steps. A crepe film comprising the film composite in accordance with the abovementioned properties also complies with this precondition. During processing of the film composite, it also exhibits adequate mechanical strength, for example, in relation to increased pressure, increased temperature, and in particular the combination of increased pressure and increased temperature. By way of example, rolls used to process the film composite to give a crepe film can be heated to 55 to 65° C., wherein the temperature in the actual film composite can be even higher because of the additional pressure to which it is exposed as a consequence of the process.

The proportion of microbeads in the first and/or second external layer here can be from 0.1 to 1% by weight, preferably from 0.4 to 0.6% by weight, for example, 0.5% by weight. The proportion of the high-molecular-weight polyethylene in the first and/or second external layer can be from 5 to 30% by weight, preferably from 10 to 20% by weight, for example, 15% by weight, and the proportion of polystyrene in the first and/or second external layer can be from 30 to 70% by weight, preferably from 35 to 55% by weight, for example, 40% by weight. Each of the components microbeads, polystyrene, and high-molecular-weight polyethylene can be present in the first and/or second external layer.

The film composite can moreover have a third middle layer arranged between the first middle layer and the second external layer, and a second middle layer arranged between the third middle layer and the second external layer. With this, the film composite has five layers, where a third middle layer is arranged between the first and second external layer and, respectively, a first and second middle layer is arranged between the third middle layer and the two external layers. The first and second middle layer can by way of example take the form of adhesion-promoter layers. The third middle layer, which takes the form of an intermediate layer between the two middle layers, can moreover provide an oil barrier in the film composite. This can be useful for an appropriate use of the film composite.

The film composite can comprise ethylene-polyacrylate copolymers as polymer which has a melting point that is lower than that of the other components of the first and/or second external layer. By way of example, butyl acrylate can be selected as a polyacrylate fraction.

The proportion of polymer in the first and/or second external layer can be 15 to 35% by weight, for example, 25% by weight. It is also possible to select the proportion of the polymer to be different in the first and in the second external layer.

If a polymer is used which has a melting point lower than that of the other components of the first and second external layer, it is possible to achieve irregular, slight, and reversible adhesion of subregions of the first external layer and of subregions of the second external layer when the film composite is compressed, for example, during a creping process, and the compressed film composite is thus additionally stabilized. However, since the adhesion is reversible once the film composite has been compressed it is easily stretched by tensile loads, but with retention of its integrity. If, by way of example ethylene-butyl acrylate is used as this type of polymer, this develops a tacky property during the compression process in which a particular temperature is used in combination with a particular pressure, thus rendering ethylene-butyl acrylate thermoplastic and making it susceptible to reversible adhesion.

The polyolefin of the first and/or second external layer can by way of example be one selected from polypropylene, polyethylene and mixtures thereof. The proportion of the polyolefin in the first and/or second external layer here can be 30 to 70% by weight. The proportion of the polyolefin in the first and second external layer can also be selected differently.

The first and/or second external layer can mutually independently comprise at least one color pigment. This can give the film composite a colored appearance on both sides as required by the application, wherein both sides can be identically colored or differently colored, or the film composite is colored only on one side. By way of example, it is possible that a side of the film composite is colored black. The proportion of color pigment in the first and/or second external layer can be 5 to 15% by weight. According to another structure, it is also possible that the first and/or second middle layer comprises a color pigment.

The third middle layer can comprise a material selected from a group consisting of ethylene-vinyl alcohol copolymers, polyvinyl alcohols, polyamides and copolyamides. It is also possible to use mixtures thereof, for example, mixtures of various polyamides or copolyamides.

Polyamides or copolyamides can be those selected from a group consisting of thermoplastic aliphatic, semiaromatic and aromatic homo- or copolyamides. The homo- and copolyamides can be those selected from diamines, for example, aliphatic diamines having from two to ten carbon atoms, in particular hexamethylenediamine, and aromatic diamines having from six to ten carbon atoms, in particular p-phenylenediamine, as well as from dicarboxylic acids, aliphatic and aromatic dicarboxylic acids having from six to fourteen carbon atoms, for example, adipic acid, terephthalic acid, or isoterephthalic acid, and from lactams, for example, ε-caprolactam. Examples of polyamides that can be used are nylon-6, nylon-12, nylon-66, nylon-6I, nylon-6T, and copolymers of these, or a mixture of at least two of the polyamides.

Polyamide and/or copolyamide provides an oil barrier for the film composite and moreover ensures the necessary strength, stiffness, and heat resistance during the processing of the film composite. If the film composite has been compressed, the structure can also be supported and stabilized by polyamide and/or copolyamide in the third middle layer. The third middle layer can moreover have gas-barrier properties, in particular oxygen-barrier properties and/or water-vapor-barrier properties.

The first and the second middle layer can mutually independently comprise a material selected from a group consisting of thermoplastic polymers, organic acids, organic anhydrides, and mixtures and compounds thereof. By way of example, the first and/or second middle layer can comprise a modified thermoplastic polymer, in particular a modified polyolefin homo- or copolymer, for example, a modified propylene homo- or copolymer, modified with at least one organic acid or with an organic anhydride, for example, maleic anhydride. The first and, if present, the second middle layer can take the form of adhesion-promoter layers and thus bring about good adhesion between the first external layer and the second external layer, or the first external layer and the third middle layer, or else the third middle layer and the second external layer. If the film composite comprises only a first middle layer between the first and the second external layer, the material for the first middle layer can be one selected from polyolefins. This can reduce or prevent delamination of the layers.

The thickness of the film composite can be one selected from 25 to 200 μm. By way of example, the thickness can be 75 μm. It is possible here that the thickness of the first and the second external layer is respectively 8 to 80 μm, the thickness of the first and the second middle layer is 3 to 20 μm, and the thickness of the third middle layer is 10 to 50 μm. By way of example, the thickness of the first and the second external layer can be 25 μm, the thickness of the first and the second middle layer can be 5 μm, and the thickness of the third middle layer can be 15 μm. According to another example, the thickness of the first and the second external layer can be 27 μm, the thickness of the first and the second middle layer can be 4 μm, and the thickness of the third middle layer can be 13 μm.

The first external layer can comprise microbeads or high-molecular-weight polyethylene. It is thus possible by way of example to provide a film composite of which the first external layer comprises a polyolefin, microbeads, or high-molecular-weight polyethylene, and a polymer of which the melting point is lower than that of the polyolefins and of the microbeads or the polyethylene, and of which the second external layer comprises a polyolefin and a polymer of which the melting point is lower than that of the polyolefin.

This type of film composite can have a first external layer which has a first surface which faces away from the first middle layer and on which uneven areas are present. The uneven areas can comprise, on the first surface, grains of a size which can be microscopic and can be one selected from 10 to 350 μm. If high-molecular-weight polyethylene is present in the first external layer, the grain size can by way of example be one selected from 10 to 60 μm, and if agglomerates of high-molecular-weight polyethylene are present, the grain size of these can be 110 to 315 μm. If microbeads are present in the first external layer, the grain size of these can be 30 to 190 μm.

This type of surface therefore exhibits roughness which is comparable by way of example with fine sandpaper. The roughness gives the film composite good transport capability by rolls which by way of example have a tungsten carbide surface. At the same time, film composites of which the surfaces have uneven areas exhibit increased resistance to abrasion during processing thereof to give a crepe film, even when the surfaces of the rolls by way of example similarly have a rough surface. The increased abrasion resistance leads to reduced formation of residues on, for example, a roll surface and thus to substantial retention of transport capability.

The film composite can comprise polystyrene in its first and second external layer. This type of film composite can therefore comprise, in the first and the second external layer, respectively, a polyolefin, polystyrene, and a polymer, which has a melting point lower than that of the polyolefin and of the polystyrene.

It is possible that the first external layer has a first surface which faces away from the first middle layer and which has a surface structure, and the second external layer has a second surface which faces away from the first middle layer and which has a surface structure. In this context, a surface structure is to be understood as an invisible roughness of the surface which is microscopic and results from the mutual repulsion between polystyrene and polyolefins in the first and second external layer. The surface structure is sufficient to achieve increased abrasion resistance of the film composite during processing to give a crepe film, for example, by rolls, and to achieve low abrasion of the film composite.

The first external layer, the second external layer, and also the first, second, and third middle layer, can, respectively, as required by the application, mutually independently comprise additives.

The additives can be those selected from a group which consists of antioxidants, antiblocking agents, antifogging agents, antistatic agents, antimicrobial active ingredients, light stabilizers, UV absorbers, UV filters, dyes, color pigments, stabilizers, for example, heat stabilizers, process stabilizers, UV stabilizers and/or light stabilizers, based by way of example on at least one sterically hindered amine (HALS), processing aids, flame retardants, nucleating agents, crystallization agents, for example, crystal-nucleating agents, lubricants, optical brighteners, flexibilizing agents, sealing agents, plasticizers, silanes, spacers, fillers, peel additives, waxes, wetting agents, compounds having surface activity, for example, surfactants, and dispersing agents.

The layers can mutually independently comprise at least one of the additives in a proportion of 0.01 to 30% by weight, in particular 0.1 to 20% by weight, based, respectively, on the total weight of an individual layer.

A film composite in accordance with the abovementioned properties and examples can be produced by blown-film extrusion.

A crepe film is also provided which comprises a film composite according to the above examples. The crepe film comprising the film composite can have parallel corrugations. In this context, this means a compressed structure of the film composite, where the compressing takes place along a direction such that the corrugations in the film composite run parallel to one another. “Parallel” here is not intended to have a precise geometric meaning, but instead to state a preferential direction of the corrugations, where individual corrugations can have an undulating shape within the preferential direction, or else can exhibit only occasional changes of direction.

The corrugations can by way of example have been produced by a creping process in which the film composite is compressed. In this context, corrugations are an undulating structure of the film composite perpendicular to the area of the film composite, where all of the layers of the film composite undulate parallel to one another. However, the undulations can be so close to one another that the distance between individual undulations is very small or indeed zero.

It is therefore possible that the first external layer and the second external layer of the film composite in the crepe film respectively have, on the surfaces that face away from the first middle layer, subregions which are in physical contact with one another. By virtue of the corrugation, therefore, subregions of the first external layer can be in contact with one another, but there is no requirement for any coherent bonding. The respective subregions of the first external layer can therefore be separated again from one another by a tensile load. Analogous considerations apply to the second external layer.

The compression factor of the crepe film comprising the film composite can be >60%, for example, 72%. The compression factor is higher than that of crepe films made from conventional film composites. This ensures improved performance due by way of example to the increased flexibility of the crepe film.

The use of a film composite according to the above examples, for a dry creping process, is moreover provided. The process can produce a crepe film according to the above examples.

The dry creping process here can by way of example comprise the dry creping process of Micrex. In this process, the film composite in the form of a web from a roll is transported over a heated tungsten carbide roll. The film composite is compressed under high pressure by rapidly moving plates to produce a concertina-like compressed structure with parallel corrugations. Compressing reduces the length of the film composite, thus defining the compression factor. As the compression factor increases, the extent to which the crepe film, i.e. the compressed film composite, can in turn be stretched in the application also increases. By virtue of the memory effect of the film composite, the stretching can be substantially reversible.

Our film composites, crepe films and methods will be explained in even more detail by using the figures and examples.

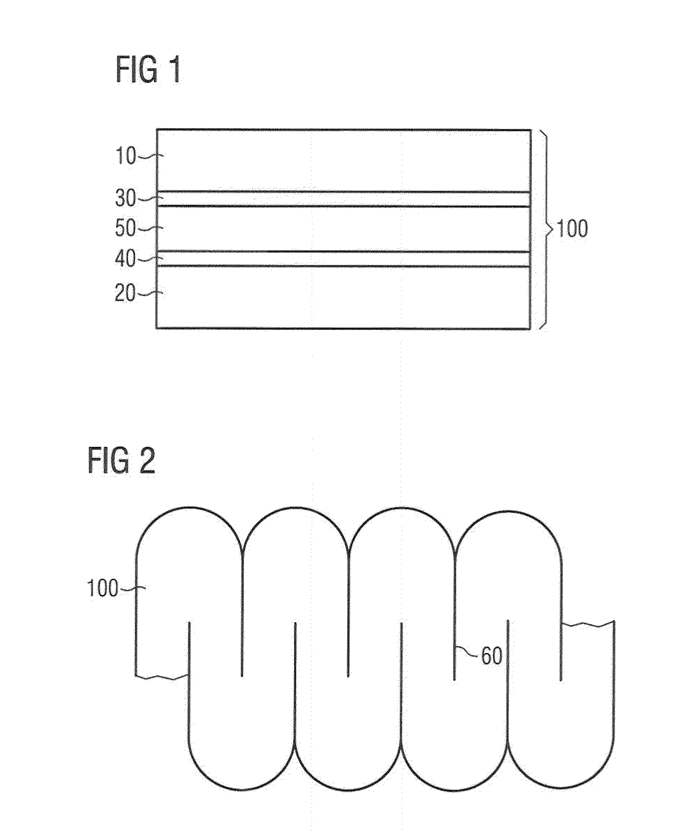

FIG. 1 shows a schematical side view of a film composite 100. The film composite 100 according to FIG. 1 shows the first external layer 10 and the second external layer 20 between which the following have been arranged: the first middle layer 30, the second middle layer 40, and between these in turn the third middle layer 50. These layers combine and result in the film composite 100. The thickness of the first and of the second external layer 10 and 20 can by way of example be 25 μm. The thicknesses of the middle layers 30 and 40 can by way of example be 5 μm, and the thickness of the third middle layer 50 can by way of example be 15 μm. The thickness of the entire film composite 100 can therefore be 75 μm.

The constitutions of the layers have been selected according to the above examples. The third middle layer 50 therefore comprises polyamides, copolyamides, or a mixture thereof. The first and second middle layer 30 and 40 comprise polyolefins, anhydride copolymers, and mixtures thereof. The first and second external layer 10 and 20 comprise, respectively, a polyolefin, for example, polypropylene, polyethylene, or a mixture thereof, and a polymer, which has a melting point that is lower than that of the other components of the first and second external layer. Furthermore, there is a polystyrene present in the first and second external layer 10 and 20, or there are microbeads or high-molecular-weight polyethylene present in the first and/or second external layer 10 and 20.

By virtue of the constitutions of the first and second external layers 10 and 20, the surfaces which, on the first and second external layer 10 and 20, face away from the first middle layer 30 have uneven areas or have surface structures (not shown here).

The film composite 100 according to FIG. 1 comprises by way of example five layers, but an analogous structure with only three layers is equally realizable, without third middle layer 50 and second middle layer 40.

FIG. 2 shows a schematical side view of a crepe film produced from the film composite 100. For simplicity, FIG. 2 does not depict the individual layers of the film composite 100. However, a crepe film can use a five-layer film composite according to FIG. 1 or a three-layer film composite. Film composites with more than five layers can also be used. The crepe film has corrugations, giving rise to subregions 60 in which the first and the second external layer 10 and 20 are respectively in physical contact with themselves. This type of crepe film can be stretched reversibly by tensile load such that the stretching can achieve the entire length of the film composite.

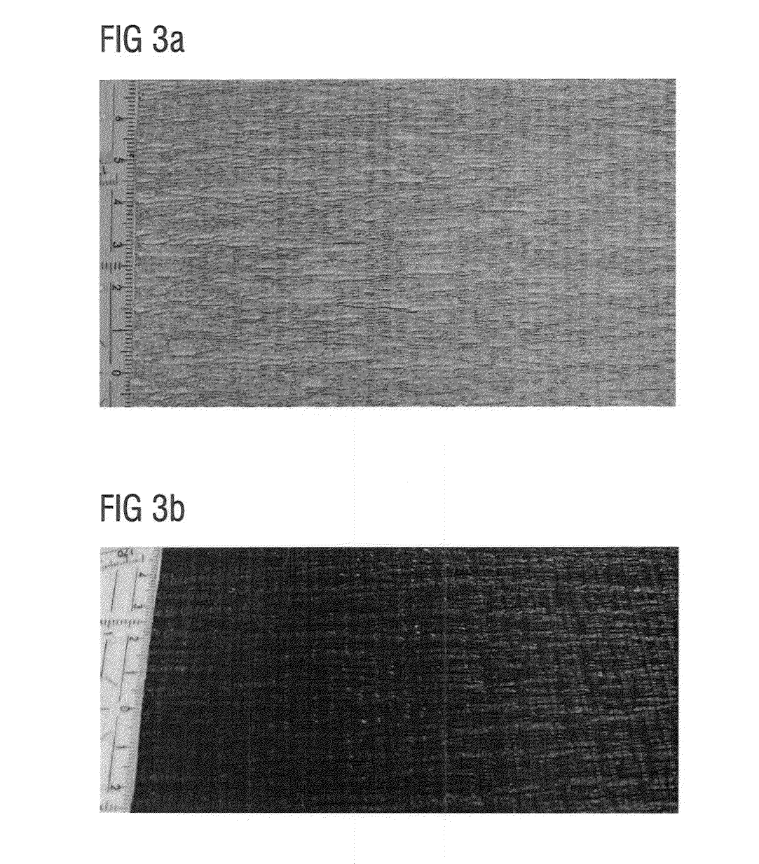

FIGS. 3a and 3b show photographs of a plan view of the frontal and reverse side of a crepe film of this type. The undulating structure existing due to the corrugations is discernible on both sides. The different colorings of the surfaces are also discernible and are due to color pigments which have been introduced in the first and the second external layer.

Three examples of constitutions of film composites are given below.

a) Five-layer film composite comprising polystyrene in the first and second external layer 10 and 20

The thickness of the first and the second external layer 10 and 20 is 25 μm, and they comprise 40% by weight of polystyrene (for example Crystal 1340 polystyrene), 35% by weight of polypropylene (for example Inspire 137), and 25% by weight of ethylene-butyl acrylate (for example Lucofin 1400 HN).

The thickness of the first and the second middle layer 30 and 40 is respectively 5 μm, and they comprise 100% by weight of a maleic anhydride-ethylene-vinyl acetate (for example Orevac 18211).

The thickness of the third middle layer 50 is 15 μm, and it comprises 75% by weight of polyamide (for example Durethan C38 F) and 25% by weight of nylon-6 (for example Durethan B40 FAM).

The total thickness of the film composite is 75 μm.

Five-layer film composite comprising high-molecular-weight polyethylene in the first external layer 10

The thickness of the first external layer 10 is 27 μm, and it comprises 55.5% by weight of polypropylene (for example Inspire 137), 15% by weight of ultrahigh-molecular-weight polyethylene (for example Constab AS 6104 LD), 17.5% by weight of ethylene-butyl acrylate (for example Lucofin 1400 HN), and 12% by weight of white color pigment (for example Remafinweiβ RCL).

The thickness of the second external layer 20 is 27 μm, and it comprises 62% by weight of polypropylene (for example Inspire 137), 25% by weight of ethylene-butyl acrylate (for example Lucofin 1400 HN), 10% by weight of black color pigment (for example Polyblak 1423/20), and 3.0% by weight of antiblocking agent (for example Multibatch MP 52659 PP).

The thickness of the first and the second middle layer 30 and 40 is respectively 4 μm, and they comprise 75% by weight of a polypropylene-maleic anhydride copolymer (for example Admer QB 520 E) and 25% by weight of homopolypropylene (for example P4 622-198X).

The thickness of the third middle layer 50 is 13 μm, and it comprises 100% by weight of polyamide (for example Durethan C38 F).

The total thickness of the film composite is 75 μm.

c) Five-layer film composite comprising microbeads in the first external layer 10

The thickness of the first external layer 10 is 27 μm, and it comprises 60% by weight of polypropylene (for example Inspire 137), 25% by weight of ethylene-butyl acrylate (for example Lucofin 1400 HN), 0.5% by weight of microbeads (for example Advancel EMS-024), 2.0% by weight of polyethylene (for example Polybatch UVS210), 0.5% by weight of a perfluorinated processing aid (for example Luvofilm 9679) incorporated into LDPE (low-density polyethylene), and 12% by weight of white color pigment (for example Remafinweiβ RCL).

The thickness of the second external layer 20 is 27 μm, and it comprises 60% by weight of polypropylene (for example Inspire 137), 25% by weight of ethylene-butyl acrylate (for example Lucofin 1400 HN), 2.0% by weight of UV stabilizer (for example Polybatch UVS210), 10% by weight of black color pigment (for example Polyblak 1423/20), and 3.0% by weight of antiblocking agent (for example Multibatch MP52659).

The thickness of the first middle layer 30 is 4 μm, and it comprises 63% by weight of a polypropylene-anhydride copolymer (for example Admer QB 520 E), 2% by weight of UV stabilizer (for example Polybatch UVS210), 25% by weight of polypropylene (for example Bormod 904), and 10% by weight of black color pigment (for example Polyblak 1420).

The thickness of the second middle layer 40 is 4 μm, and it comprises 73% by weight of a polypropylene-anhydride copolymer (for example Admer Q13 520 E), 2% by weight of polyethylene (for example Polybatch UVS210), and 25% by weight of polypropylene (for example Bormod 904).

The thickness of the third middle layer 50 is 13 μm, and it comprises 100% by weight of polyamide (for example Durethan C38 F).

The total thickness of the film composite is 75 μm.

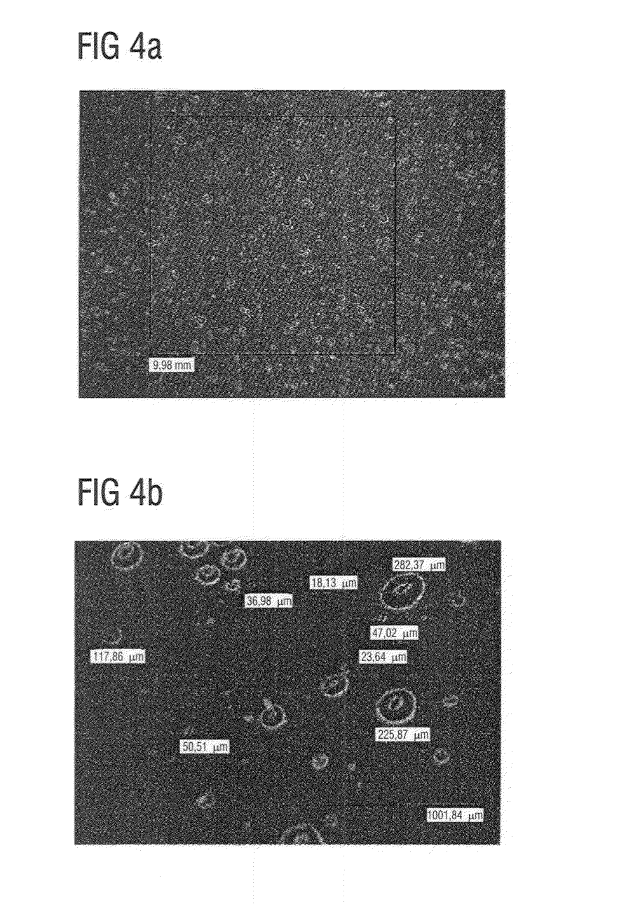

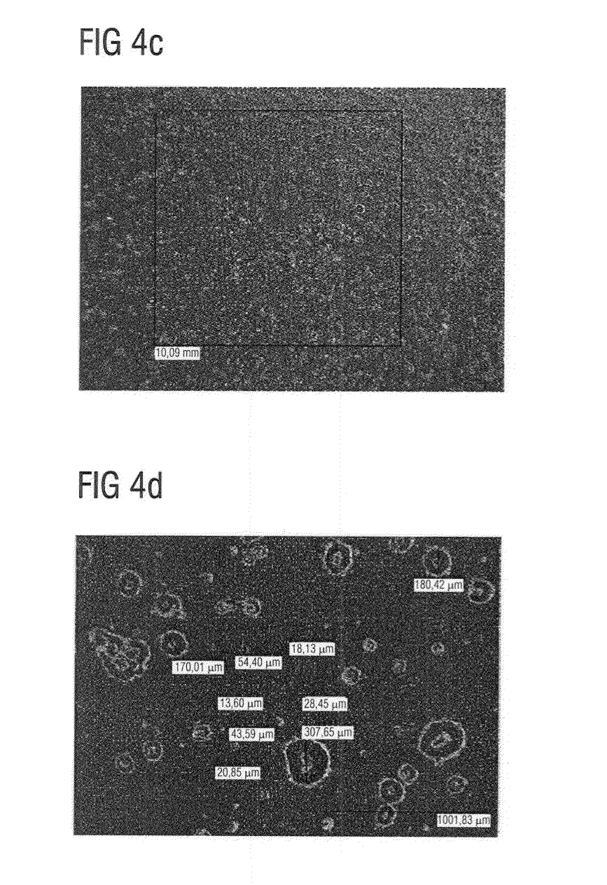

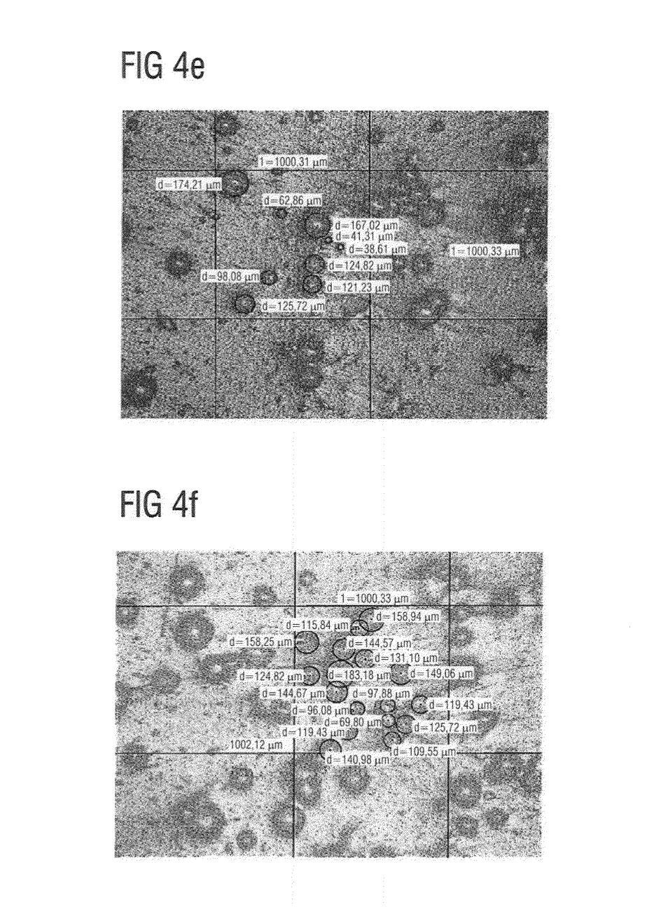

FIGS. 4a to 4f show enlarged photographs of plan views of surfaces of film composites according to several examples. These photographs reveal the uneven areas on the surfaces of the external layers of the film composites which contribute to the good processability of the film composites.

FIGS. 4a and 4b show two different enlargements of the surface of a film composite of which the external layer comprises high-molecular-weight polyethylene at a concentration of 15% by weight. The grain sizes of the uneven areas on the surface can be seen to be from 18 μm to 282 μm.

FIGS. 4c and 4d show an example analogous to FIGS. 4a and 4b, but the proportion present of the high-molecular-weight polyethylene in the external layer is 30% by weight. The grain sizes here are from 18 μm to 307 μm.

FIGS. 4e and 4f are enlarged photographs of plan views of surfaces of film composites according to another example, in which microbeads are present in the respective external layer depicted. Grain sizes of the uneven areas can be seen in these examples and comprise the range from 38 μm to 183 μm.

Although the apparatus and methods have been described in connection with specific forms thereof, it will be appreciated that a wide variety of equivalents may be substituted for the specified elements described herein without departing from the spirit and scope of this disclosure as described in the appended claims.

1. A film composite comprising:
a first external layer and a second external layer, and
a first middle layer between the first and the second external layer, wherein the first and/or second external layer comprise components which comprise at least:
a polyolefin,
a component selected from the group consisting of microbeads, polystyrene, and high-molecular-weight polyethylene, and
a polymer having a melting point lower than that of other components of the first and/or second external layer.

2. The film composite according to claim 1, further comprising a third middle layer between the first middle layer and the second external layer and a second middle layer between the third middle layer and the second external layer.

3. The film composite according to claim 1, wherein the polymer having a melting point lower than that of the other components of the first and/or second external layer is selected from ethylene-polyacrylate copolymers.

4. The film composite according to claim 1, wherein the polyolefin is at least one selected from the group consisting of polypropylene and polyethylene.

5. The film composite according to claim 1, wherein the first and/or second external layer mutually independently comprise at least one color pigment.

6. The film composite according to claim 2, wherein the third middle layer comprises a material selected from the group consisting of ethylene-vinyl alcohol copolymers, polyvinyl alcohols, polyamides, copolyamides, and mixtures thereof.

7. The film composite according to claim 2, wherein the first and the second middle layer comprise a material selected from the group consisting of thermoplastic polymers, organic acids, organic anhydrides, mixtures thereof and compounds thereof.

8. The film composite according to claim 1, wherein the first external layer comprises microbeads or high-molecular-weight polyethylene.

9. The film composite according to claim 1, wherein the first external layer has a first surface which faces away from the first middle layer and on which uneven areas are present.

10. The film composite according to claim 1, wherein the first and the second external layer comprise polystyrene.

11. The film composite according to claim 10, wherein the first external layer has a first surface facing away from the first middle layer and has a surface structure, and the second external layer has a second surface facing away from the first middle layer and has a surface structure.

12. A crepe film comprising a film composite according to claim 1, having parallel corrugations.

13. The crepe film according to claim 12, where the first external layer and the second external layer of the film composite respectively have, on surfaces facing from the first middle layer, subregions in physical contact with one another.

14. The crepe film according to claim 12, having a compression factor of >60%.
